(19) United States
(12) Patent Application Publication
(10) Pub. No.: US 2003/0049181 A1
(43) Pub. Date: Mar. 13, 2003

(54) Exhaust system for motor vehicles

(76) Inventor: Hermann Ermer, Burgthann (DE)

Correspondence Address: LERNER AND GREENBERG, P.A., Post Office Box 2480, Hollywood, FL, 33022-2480, US

(21) Appl. No.: 10/234,549

(22) Filed: Sep. 4, 2002

(30) Foreign Application Priority Data
Sep. 4, 2001 (DE) 101 43 364.6-13

(51) Int. Cl. B01D 53/34; B32B 27/02

(52) U.S. Cl. 422/168; 422/177

(57) ABSTRACT

An exhaust system for a motor vehicle includes a heat exchanger that protects a NOₓ storage device against exposure to extraneous temperatures. The heat exchanger is formed from an outer and an inner pipe. A radial gap is formed between the two pipes which, at its front end facing in the opposite direction to the direction of flow, has a seal that prevents exhaust gas from entering. The region of the inner pipe which adjoins the seal is interrupted by bypass openings. At a rear end, which faces in the direction of flow, the inner pipe is formed with an outlet opening and the inner pipe is narrowed in the manner of a nozzle. The outlet opening is connected to the radial gap.

### BACKGROUND OF THE INVENTION

### FIELD OF THE INVENTION

The invention relates to an exhaust system for motor vehicles. Exhaust systems of the type are very often equipped with a nitrogen oxide storage catalytic converter, referred to below as NOₓ storage device. The storage device is generally connected downstream of an exhaust catalytic converter and it is located relatively close to the engine, or at least close enough for there to be a risk, during full-load operation, wherein exhaust temperatures of up to 950° C. are reached, of the maximum permissible operating temperature of the NOₓ storage device, which lies in the range from approximately 750° C. to 800° C., being exceeded and of this storage device being destroyed. This can be prevented by connecting a heat exchanger upstream of the NOₓ storage device.

A NOₓ storage device operates with a good level of efficiency in a temperature range from approximately 250° C. to 450° C. Accordingly, during the cold-start phase and in lower load ranges, it is attempted to feed the exhaust gas to the NOₓ storage device as far as possible in an uncooled state and without any heat loss, so that the required operating temperature is reached as quickly as possible. However, the heat exchanger connected upstream of the NOₓ storage device runs counter to this objective.

One solution to this problem could consist in providing a bypass, which is controlled with the aid of a valve, at the heat exchanger. The exhaust gas is passed through the heat exchanger when cooling is required in the upper load range and is guided through the bypass when a high level of heat needs to be supplied to the NOₓ storage device. A drawback of that solution is that it is structurally complex and susceptible to faults. The differing heat requirements of the NOₓ storage device could also be taken into account by a corresponding engine management system. The temperature of the exhaust gas could be increased by additional injection, while the temperature of the exhaust gas could be reduced by enriching the fuel/air mixture. However, both of these solutions lead to increased fuel consumption.

### SUMMARY OF THE INVENTION

It is accordingly an object of the invention to provide an exhaust system for a motor vehicle, which overcomes the above-mentioned disadvantages of the heretofore-known devices and methods of this general type and wherein a heat exchanger is connected upstream of the NOₓ storage device, allowing exhaust-gas heat to be supplied and dissipated in dependence on the load in a structurally simple and reliably operating manner.

With the foregoing and other objects in view there is provided, in accordance with the invention, a heat exchanger in an exhaust system for a motor vehicle. The heat exchanger comprises:

an inner pipe and an outer pipe disposed to form a radial gap with the inner pipe;

a front end facing in an opposite direction to a direction of flow through the heat exchanger, and a rear end distal from the front end;

a seal at the front end preventing exhaust gas from entering into the radial gap;

the inner pipe having bypass openings formed therein in a region adjoining the seal; and

the inner pipe having an outlet opening at the read end, the inner pipe being narrowed at the rear end to form a nozzle, and the outlet opening being connected to the radial gap.

In other words, the objects of the invention are achieved with a heat exchanger that is connected upstream of the NOₓ storage device and that is formed from an outer pipe and an inner pipe, between which there is a radial gap. The latter is sealed at its front end, i.e. the end which faces in the opposite direction to the direction of flow (i.e., into the flow), so that it is impossible for exhaust gas to pass into the radial gap. In a section of the inner pipe which adjoins the seal, there are bypass openings, through which exhaust gas can pass into the radial gap. The rear end, which faces in the direction of flow, of the inner pipe comprises an outlet opening and is narrowed in the manner of a nozzle, the outlet opening being connected to the radial gap. In a heat exchanger which is designed in this manner, in the lower partial-load range, i.e. for example during the starting phase or while tests are being carried out to check that the exhaust system is operating correctly, the exhaust gas flows through the inner pipe without significant quantities of exhaust gas passing through the bypass openings into the radial gap, where it is cooled at the inner surface of the outer pipe which is in communication with the atmosphere. As the flow rate increases and the flow resistance increases to the power of two in the inner pipe, the relative proportion of the exhaust gas which passes into the radial gap and therefore the cooling action of the heat exchanger increase. The passage of exhaust gas into the radial gap is caused by the end of the inner pipe which is narrowed in the manner of a nozzle, as will be explained in more detail below, or can be matched to the engine by means of the size of the nozzle cross section. Moreover, this configuration acts as a suction jet pump, i.e. the exhaust-gas stream which flows out of the narrowed end of the inner pipe entrains exhaust-gas particles flowing in from the radial gap (ejector effect). This effect can be intensified further if the outlet opening of the narrowed end is surrounded at a radial distance by a pipe section, i.e. if there is a structure which is known in water jet pumps as a collection cage. The front end of the pipe section is radially widened and is connected in a sealed manner to the inner surface of the outer pipe.

The inner pipe is preferably configured in such a way that sections which are interrupted by bypass openings alternate with uninterrupted longitudinal sections. On the outer pipe there are beads which bulge inward and reduce the clear width of the radial gap. The effect of these beads is that the exhaust gas which has passed into the radial gap becomes turbulent at the beads, and in this way the cooling action of the heat exchanger is increased.

Furthermore, the cooling action of the heat exchanger can be improved by increasing the surface area or by means of cooling structures which are present on the outer surface of the outer pipe. There are preferably in each case two webs which protrude laterally and extend in the longitudinal direction.

Passage openings are formed in these webs. Furthermore, on the underside of the webs, in the region of the passage openings, there are air-guiding elements which guide the air stream from the bottom upward through the passage openings onto the top side of the heat exchanger and therefore between these and the floor assembly of the vehicle. This ensures that even the top side of the heat exchanger, which faces toward the floor assembly of the vehicle, has sufficient air stream or cooling air flowing around it.

Other features which are considered as characteristic for the invention are set forth in the appended claims.

Although the invention is illustrated and described herein as embodied in an exhaust system for motor vehicles, it is nevertheless not intended to be limited to the details shown, since various modifications and structural changes may be made therein without departing from the spirit of the invention and within the scope and range of equivalents of the claims.

The construction and method of operation of the invention, however, together with additional objects and advantages thereof will be best understood from the following description of specific embodiments when read in connection with the accompanying drawings.

### DESCRIPTION OF THE PREFERRED EMBODIMENTS

FIG. 1 is a perspective illustration of a heat exchanger;

FIG. 2 is a plan view in the direction of arrow II in FIG. 1;

FIG. 3 is a longitudinal section taken along the line III-III in FIG. 1 and illustrating a first embodiment of the invention;

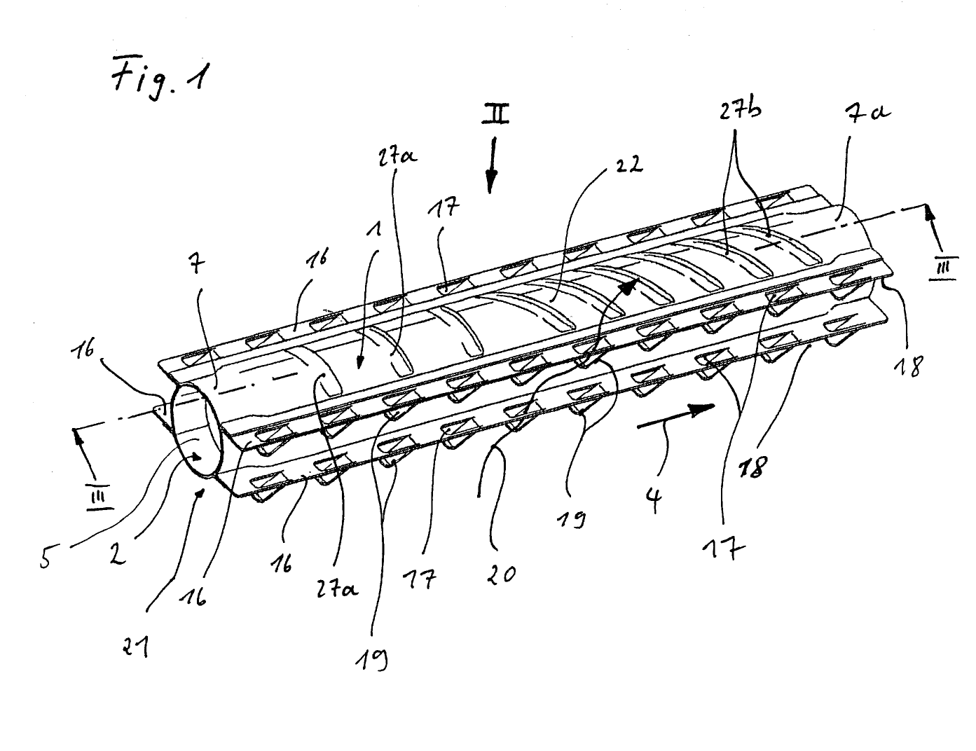

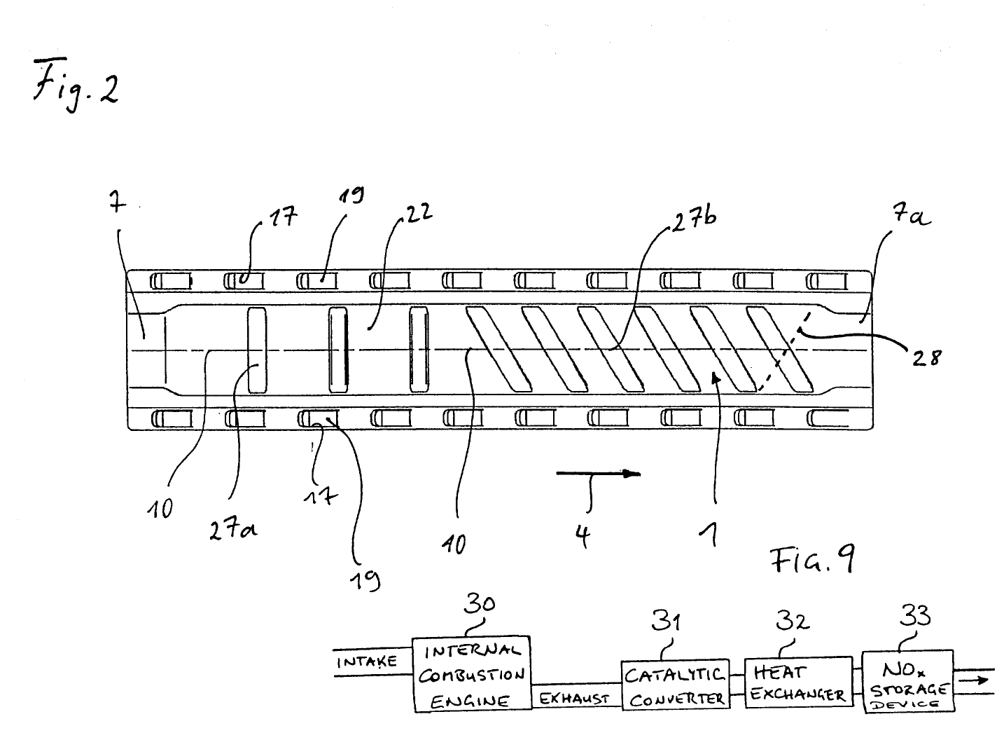

FIG. 4 is a similar view of a further embodiment;

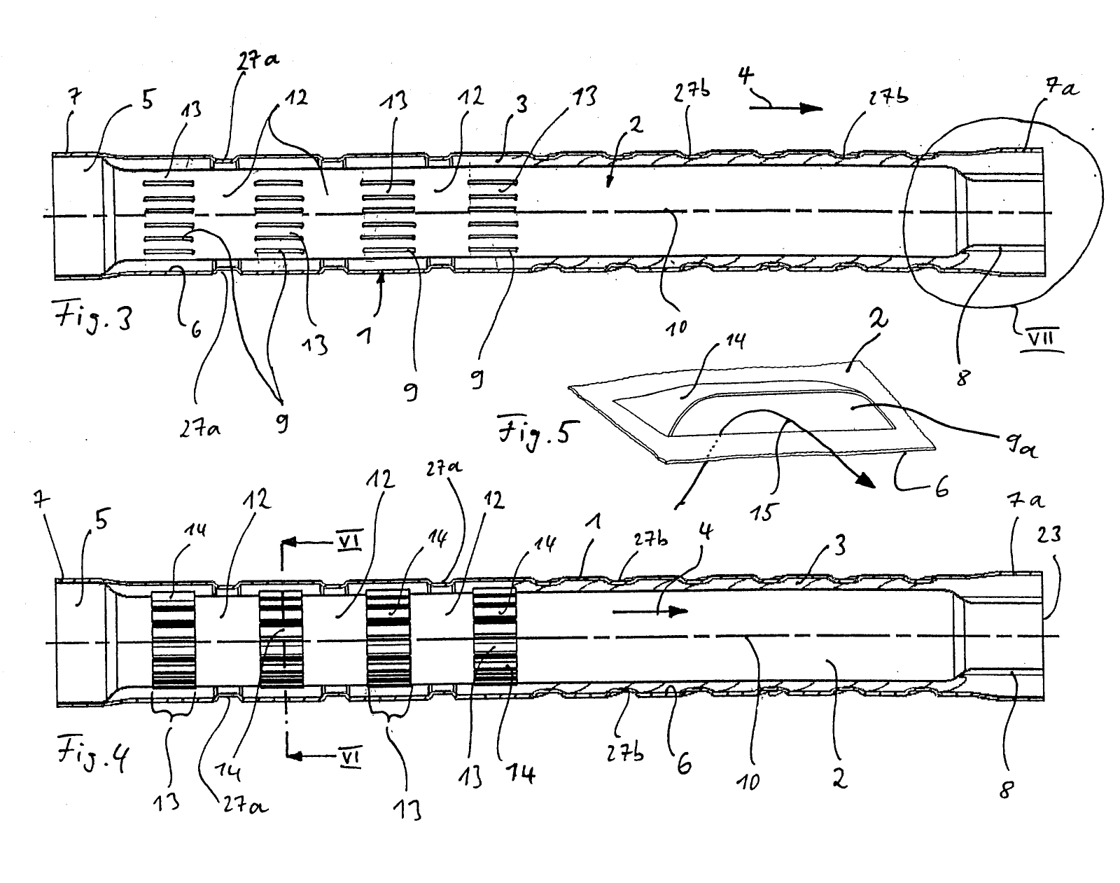

FIG. 5 is an enlarged perspective illustration of a bypass opening in the inner pipe of the heat exchanger of in FIG. 4;

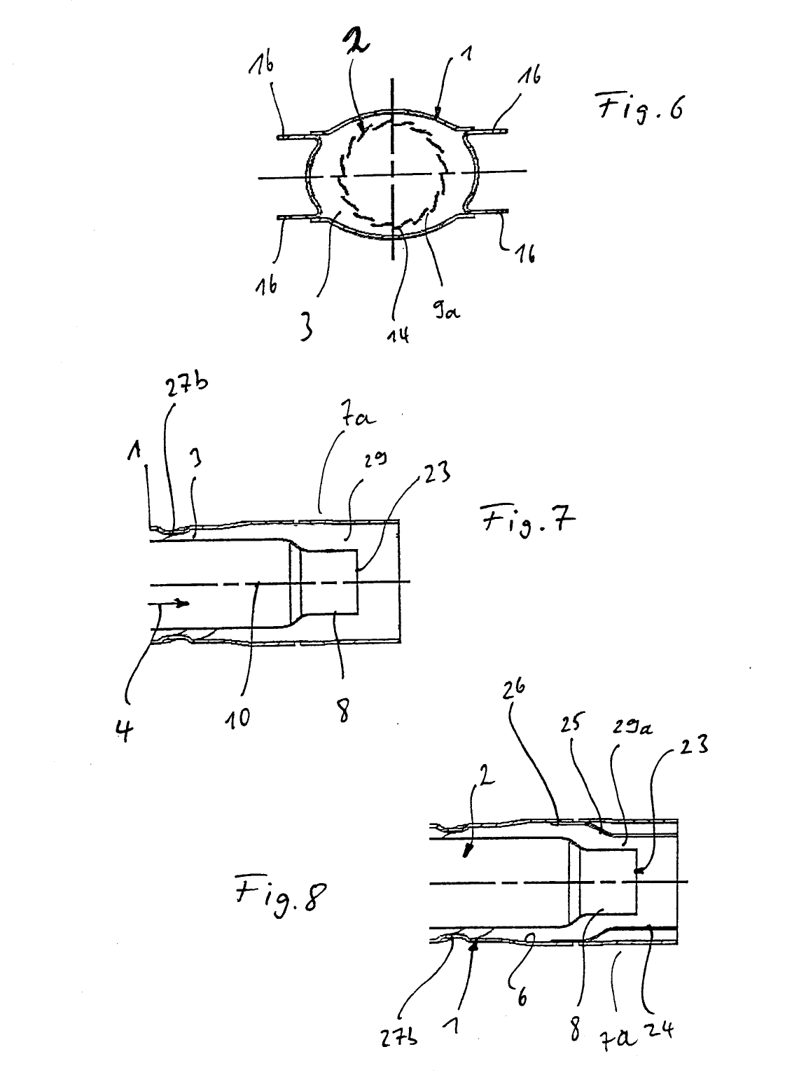

FIG. 6 is a cross section taken along the line VI-VI in FIG. 4 and viewed in the direction of the arrows;

FIG. 7 is an end section of the heat exchanger corresponding to the detail VII in FIG. 3;

FIG. 8 is a similar view of a differently configured end section of the heat exchanger; and

FIG. 9 is a schematic view of an exhaust system of a motor vehicle with a heat exchanger according to the invention.

### DESCRIPTION OF THE PREFERRED EMBODIMENTS

Referring now to the figures of the drawing in detail and first, particularly, to FIG. 1 thereof, the main components of the heat exchanger include an outer pipe 1 and an inner pipe 2. The two pipes are disposed substantially concentrically with respect to one another, leaving a radial gap 3 open between them. The radial gap is sealed at its front end of the heat exchanger, which faces in the opposite direction to a direction of flow 4, i.e., against the flow. The seal is brought about by the inner pipe 2 having a radially widened section 5, which bears in a sealed manner against the inner surface 6 of the outer pipe 1. This prevents exhaust gas from flowing into the radial gap 3. The inner pipe is preferably circular in cross section. The outer pipe may likewise be formed in this way. In the exemplary embodiments illustrated in the figures, however, the outer pipe 1 is substantially oval in cross section. Only the end regions 7, 7a of the outer pipe 1 are circular in cross section, in order to simplify the connection of conventional exhaust pipes.

The inner pipe 2 is fixed to the outer pipe 1 only by way of its radially widened section 5, in particular by welding. Otherwise, it extends freely into the interior of the outer pipe 1. The inner pipe 2 is produced, for example, from austenitic steel and is of thin-walled design, in order to keep its mass low. The rear end 8, which faces in the direction of flow 4, is radially narrowed in the manner of a nozzle. The pipe wall of this region is of cylindrical design. However, it is also conceivable for the narrowed region to taper conically in the direction of flow 4.

Bypass openings 9 are provided in a region which adjoins the radially widened section 5 of the inner pipe 2. The bypass openings 9, in a preferred embodiment, are slots extending parallel to the longitudinal center axis 10 of the inner pipe 2. The bypass openings 9 are in each case arranged in longitudinal sections 13 which are separated from one another by uninterrupted longitudinal sections 12, the longitudinal sections 13 being distributed uniformly in the peripheral direction. The rear region, facing in the direction of flow 4, of the inner pipe 2 is free of apertures, the length of this region being approximately half that of the inner pipe 2.

In the exemplary embodiment shown in FIG. 4, the pipe-wall regions 14 disposed between the bypass openings 9 bulge radially outward, with the result that the exhaust gas flowing out is diverted in the peripheral direction, as indicated by the arrow 15 in FIG. 5.

In each case two webs 16, which run in the direction of the longitudinal center axis 10 of the heat exchanger, preferably extend over the entire length of the outer pipe 1 and are spaced apart in the circumferential direction or—as seen in the installed position—in the vertical direction, and which, as structures which increase the surface area, improve the cooling action of the heat exchanger, are present laterally on the outer pipe 1. Passage openings 17 are formed in the webs 16. Air-guiding elements 19 protrude from that side of the webs 16 which forms the underside 18 in the installed position. These elements cause air stream to be guided from the underside 21 of the heat exchanger onto its top side 22, as indicated by the arrow 20 in FIG. 1. The air-guiding elements 19 are tabs which have been stamped out of the webs and angled off downward. The holes which then remain in the webs 16 form the passage openings 17.

In the exemplary embodiment illustrated in FIG. 8, the narrowed rear end 8 of the inner pipe 2 and its outlet opening 23 are surrounded at a radial distance by a pipe section 24. The front end of this pipe section merges by way of an inclined shoulder 25 into a radially widened section 26 which bears in a sealed manner against the inner surface 6 of the outer pipe 1, in particular is welded to it. Beads 27 which bulge inward are present on the top side 22 and the underside 21 of the outer pipe 1. In the front half of the outer pipe 1, which adjoins the front end region 7, there are in each case two beads 27a, which extend in the peripheral direction, specifically one on the underside 21 and one on the top side 22, in the region of the uninterrupted longitudinal sections 12 of the inner pipe 2. In the rear half of the outer pipe, the beads 27b run at an angle with respect to the longitudinal center axis 10. The top side 22 of the outer pipe 1 is visible in FIG. 2. On the underside, which is not visible, the beads 27b run in the direction indicated by the dashed line 28.

The heat exchanger according to the invention operates as follows: in a lower partial-load range, i.e. at low rotational speeds of the engine, a relatively small exhaust-gas stream passes through the inner pipe 2 of the heat exchanger, and the exhaust gas is at a relatively low temperature. The exhaust gas is cooled further by the internals and pipes of the exhaust system connected upstream of a NOₓ storage device, so that the minimum operating temperature of the NOₓ storage device, which lies at around 250° C., may not be reached. This storage device is then unable to fulfill its function, namely that of retaining nitrogen oxide by chemisorption from the exhaust gas. Therefore, it must be ensured that the exhaust gas is passed to the NOₓ storage device with the minimum possible heat loss. As stated above, the quantity of exhaust gas discharged from the engine is low in this operating state. The flow rate or the quantity of exhaust gas which passes through the inner pipe per unit time is correspondingly low. The proportion of exhaust gas which passes via the bypass openings 9 into the radial gap 3, where it is cooled at the inner surface 6 of the outer pipe, is low. The heat loss from the exhaust gas is correspondingly low. The effect of the narrowed end 8 is that in this region the flow rate increases, on account of the smaller cross section of flow. In such cases, the static pressure of a flowing medium is known to decrease. Therefore, a lower pressure prevails in the region of the outlet opening 23 than in the inner pipe 2. The effect of said pressure difference is that exhaust gas is sucked via the bypass openings 9 into the radial gap 3. However, said effects are minor in the lower part-load range, i.e. at very low flow rates. On the other hand, in the full-load range, when very high flow rates are present, these effects increase, in such a manner that the proportion of the quantity of exhaust gas which flows via the radial gap and is therefore cooled increases relative to the quantity of exhaust gas which flows through the inner pipe 2. In the full-load range, i.e. when the NOₓ storage device is to be protected from overheating, the efficiency of the heat exchanger increases automatically and without the use of any complicated valves which are susceptible to faults. The beads which are present in the outer pipe 1 at certain locations narrow the radial gap and form obstacles to the exhaust gas flowing in, at which turbulence is generated, with the result that the cooling action of the heat exchanger is improved. The same is true of the design of the bypass openings 9a of the exemplary embodiment illustrated in FIGS. 4, 5. Moreover, diverting the exhaust-gas flow in the peripheral direction (arrow 15 in FIG. 5) results in a circular flow of the exhaust gas and therefore in a longer residence time in the heat exchanger. The inclined beads 27b in the rear part of the outer pipe 1 also act in this way. The passage of exhaust gas via the bypass openings into the radial gap is brought about not only by the above-mentioned pressure difference, but also to a certain extent by an effect which is known from water or steam jet pumps. The exhaust-gas flow which emerges from the narrowed end 8 entrains exhaust-gas particles which are situated in the annular space 29 surrounding the end 8.

As a result, a reduced pressure is formed upstream, and this in turn increases the quantity of exhaust gas which emerges through the bypass openings. This effect can be intensified further as a result of the end 8, as shown in FIG. 8, being surrounded by a pipe section 24, with the result that a narrowed annular space 29a is formed and the above-described effect is made more intense.

FIG. 9 illustrates an exemplary arrangement of the above-described heat-exchanger in an exhaust system of a motor vehicle. An internal combustion engine 30 is illustrated with an intake and an exhaust pipe issuing from an exhaust manifold. A catalytic converter 31 follows immediately downstream in the exhaust flow direction, in close vicinity to the engine 30. The catalytic converter 31 is followed by a heat exchanger 32 which, in turn, is followed by a NOₓ storage device 33.

I claim:

1. In an exhaust system for a motor vehicle, a heat exchanger, comprising:
an inner pipe;
an outer pipe disposed to form a radial gap with said inner pipe;
a front end facing in an opposite direction to a direction of flow through the heat exchanger, and a rear end distal from said front end;
a seal at said front end preventing exhaust gas from entering into said radial gap;
said inner pipe having bypass openings formed therein in a region adjoining said seal; and
said inner pipe having an outlet opening at said read end, said inner pipe being narrowed at said rear end to form a nozzle, and said outlet opening being connected to said radial gap.

2. The exhaust system according to claim 1, which comprises a pipe section surrounding said rear end of said inner pipe at a radial distance, said pipe section having a radially widened front end sealingly bearing against an inner wall surface of said outer pipe.

3. The exhaust system according to claim 1, wherein said inner pipe includes longitudinal segments formed with bypass openings alternating with uninterrupted longitudinal segments.

4. The exhaust system according to claim 1, wherein said outer pipe is formed with inwardly bulging beads reducing a clear width of said radial gap.

5. The exhaust system according to claim 3, wherein said outer pipe is formed with inwardly bulging beads reducing a clear width of said radial gap and in each case at least one bead, extending in a peripheral direction, is formed at an uninterrupted longitudinal section.

6. The exhaust system according to claim 1, wherein said inner pipe is formed with an aperture-free region extending as far as said rear end and adjoining a region of said inner pipe formed with bypass openings, and wherein beads extend at an angle with respect to a longitudinal center axis of said inner and outer pipes are formed on said outer pipe at the aperture-free region of said inner pipe.

7. The exhaust system according to claim 1, which comprises cooling structures for increasing a surface area formed on an outer surface of said outer pipe.

8. The exhaust system according to claim 7, wherein said cooling structures are laterally protruding webs extending in an axial direction.

9. The exhaust system according to claim 8, wherein said webs are formed with passage openings, and air-guiding elements are disposed on an underside of said webs, said air-guiding elements guiding an air stream from a bottom upward through said passage openings onto a top side of the heat exchanger.
